(19) United States
(12) Patent Application Publication
(10) Pub. No.: US 2024/0061697 A1
(43) Pub. Date: Feb. 22, 2024

(54) PROVIDING TRUSTED DEVICES FINE GRAINED ACCESS INTO PRIVATE MEMORY OF TRUSTED EXECUTION ENVIRONMENT

(71) Applicant: Intel Corporation, Santa Clara, CA (US)

(72) Inventors: RESHMA LAL, Portland, OR (US); KRYSTOF ZMUDZINSKI, Forest Grove, OR (US); PRADEEP PAPPACHAN, Tualatin, OR (US)

(73) Assignee: Intel Corporation, Santa Clara, CA (US)

(21) Appl. No.: 17/820,950

(22) Filed: Aug. 19, 2022

(51) Int. Cl. G06F 9/455

(52) U.S. Cl. CPC G06F 9/45558; G06F 9/45545; G06F 2009/45579; G06F 2009/45583

(57) ABSTRACT

An apparatus comprises a hardware processor to create an input/output control data structure (IOCS) for a trusted execution environment (TEE), allocate an input/output (I/O) address range comprising a host physical address (HPA) and a plurality of input/output (IO) pages to the input/output control structure, create an entry in the input/output control structure (IOCS) for a set of input/output (IO) pages and a device identifier for a remote device, set a pending bit to a first value which indicates that the remote device is authorized to access the input/output (I/O) address range, and grant the remote device access to the set of input/output pages in the input/output control structure upon verification of an input/output (IO) address range for the remote device.

### BACKGROUND

In computing, a virtual machine (VM) is an emulation of a computer system. VMs are based on a specific computer architecture and provide the functionality of an underlying physical computer system. Their implementations may involve specialized hardware, software, or a combination. A Virtual Machine Monitor (VMM) (also known as a hypervisor) is a software program that enables the creation, management and governance of VMs and manages the operation of a virtualized environment on top of a physical host machine. A VMM is the primary software behind virtualization environments and implementations. When installed over a host machine, VMM facilitates the creation of VMs, each with separate operating systems (OS) and applications. VMM manages the backend operation of these VMs by allocating the necessary computing, memory, storage and other input/output (I/O) resources. VMM also provides a centralized interface for managing the entire operation, status and availability of VMs that are installed over a single host machine or spread across different and interconnected hosts.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1A is a block diagram illustrating an example computing system that provides isolation in virtualized systems using trust domains, in accordance with embodiments.

FIG. 1B is a block diagram illustrating another example computing system that provides isolation in virtualized systems using trust domains, in accordance with embodiments.

FIG. 2A is a block diagram of an example of a trust domain architecture, in accordance with embodiments.

FIG. 2B is a block diagram of another example of a trust domain architecture, in accordance with embodiments.

FIG. 3 illustrates another example computing system, in accordance with embodiments.

FIG. 4 is a simplified flow diagram of at least one embodiment of a method to provide fine grained access into private memory of a trusted execution environment, in accordance with some embodiments.

FIG. 5 is a simplified flow diagram of at least one embodiment of a method to provide fine grained access into private memory of a trusted execution environment, in accordance with some embodiments.

FIG. 6 is a simplified flow diagram of at least one embodiment of a method to provide fine grained access into private memory of a trusted execution environment, in accordance with some embodiments.

FIG. 7 illustrates steps in a page table walk, in accordance with embodiments.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

As contemplated in the present disclosure, embodiments of the present invention include a processor security capability called Trusted Domain Extensions (TDX) to meet increased security objectives via the use of memory encryption and integrity via memory controller engines. As used in TDX, a Trusted Domain (TD) is a protected VM. Embodiments of the present invention deter page remapping attacks from a malicious or exploited VMM on the private memory address space of a TD.

Embodiments comprise an additional extended page table (EPT) structure called a Secure Extended Page Table (SEPT) that is used by a processor for TD private page walks. The SEPT is a per-TD EPT (i.e., each TD has its own SEPT) that is managed by a Trusted Domain Resource Manager (TDRM) only via special instructions newly added to the instruction set architecture (ISA) of the processor. The TDRM cannot alter SEPT without using these instructions otherwise an integrity failure will be reported by the processor. In other embodiments, all or parts of the SEPT may be access-controlled using processor range-register protection.

In typical VM implementations, the processor supports one EPT pointer (EPTP) per virtual memory control structure (VMCS). The VMCS is a data structure in memory that exists once per VM, while the VM is managed by the VMM. With every change of the execution context between different VMs, the VMCS is restored for the current VM, thereby defining the state of the VM's virtual processor. The VMM manages the EPT referenced by the EPTP. In embodiments of the present invention, the VMs may be encapsulated by TDs, and the VMCS may be replaced by an analogous control structure called the Trusted Domain Control Structure (TDCS) that manages the guest state of TDs.

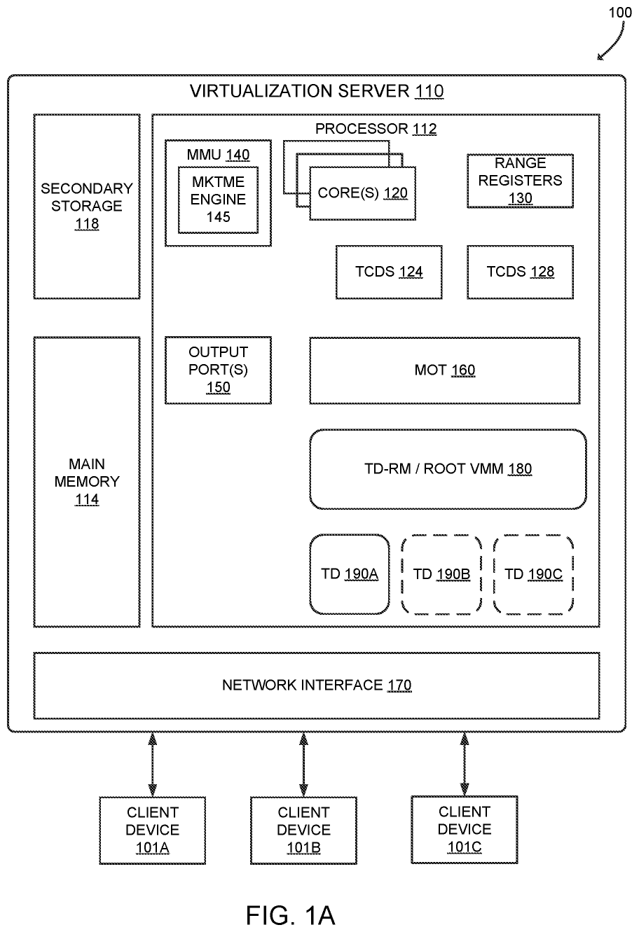

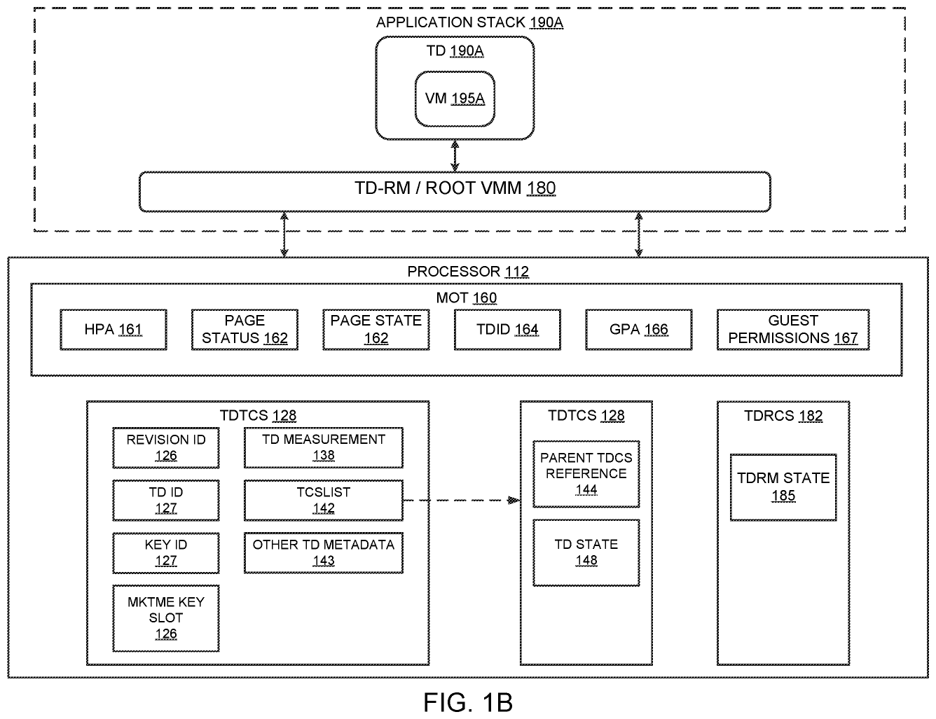

FIG. 1A is a block diagram illustrating an example computing system that provides isolation in virtualized systems using trust domains, in accordance with embodiments. The virtualization system 100 includes a virtualization server 110 that supports a number of client devices 101A-101C. The virtualization server 110 includes at least one processor 112 (also referred to as a processing device) that executes a TDRM 180. The TDRM 180 may include a VMM (may also be referred to as hypervisor) that may instantiate one or more TDs 190A-190C accessible by the client devices 101A-101C via a network interface 170. The client devices 101A-101C may include, but is not limited to, a desktop computer, a tablet computer, a laptop computer, a netbook, a notebook computer, a personal digital assistant (PDA), a server, a workstation, a cellular telephone, a mobile computing device, a smart phone, an Internet appliance or any other type of computing device.

A TD may refer to a tenant (e.g., customer) workload. The tenant workload can include an OS alone along with other ring-3 applications running on top of the OS, or can include a VM running on top of a VMM along with other ring-3 applications, for example. In implementations of the disclosure, each TD may be cryptographically isolated in memory using a separate exclusive key for encrypting the memory (holding code and data) associated with the TD.

Processor 112 may include one or more cores 120 (also referred to as processing cores 120), range registers 130, a memory management unit (MMU) 140, and output port(s) 150. FIG. 1B is a schematic block diagram of a detailed view of a processor core 120 executing a TDRM 180 in communication with a MOT 160 and one or more trust domain control structure(s) (TDCS(s)) 124 and trust domain thread control structure(s) (TDTCS(s)) 128, as shown in FIG. 1A. TDTCS and TD-TCS may be used interchangeable herein. Processor 112 may be used in a system that includes, but is not limited to, a desktop computer, a tablet computer, a laptop computer, a netbook, a notebook computer, a PDA, a server, a workstation, a cellular telephone, a mobile computing device, a smart phone, an Internet appliance or any other type of computing device. In another implementation, processor 112 may be used in a SoC system.

The computing system 100 is representative of processing systems based on micro-processing devices available from Intel Corporation of Santa Clara, Calif., although other systems (including PCs having other micro-processing devices, engineering workstations, set-top boxes and the like) may also be used. In one implementation, sample system 100 executes a version of the WINDOWS™. operating system available from Microsoft Corporation of Redmond, Wash., although other operating systems (UNIX and Linux for example), embedded software, and/or graphical user interfaces, may also be used. Thus, implementations of the disclosure are not limited to any specific combination of hardware circuitry and software.

The one or more processing cores 120 execute instructions of the system. The processing core 120 includes, but is not limited to, pre-fetch logic to fetch instructions, decode logic to decode the instructions, execution logic to execute instructions and the like. In an implementation, the computing system 100 includes a component, such as the processor 112 to employ execution units including logic to perform algorithms for processing data.

The virtualization server 110 includes a main memory 114 and a secondary storage 118 to store program binaries and OS driver events. Data in the secondary storage 118 may be stored in blocks referred to as pages, and each page may correspond to a set of physical memory addresses. The virtualization server 110 may employ virtual memory management in which applications run by the core(s) 120, such as the TDs 190A-190C, use virtual memory addresses that are mapped to guest physical memory addresses, and guest physical memory addresses are mapped to host/system physical addresses by MMU 140.

The core 120 may execute the MMU 140 to load pages from the secondary storage 118 into the main memory 114 (which includes a volatile memory and/or a nonvolatile memory) for faster access by software running on the processor 112 (e.g., on the core). When one of the TDs 190A-190C attempts to access a virtual memory address that corresponds to a physical memory address of a page loaded into the main memory 114, the MMU 140 returns the requested data. The core 120 may execute the VMM portion of TDRM 180 to translate guest physical addresses to host physical addresses of main memory and provide parameters for a protocol that allows the core 120 to read, walk and interpret these mappings.

In one implementation, processor 112 implements a TD architecture and ISA extensions (TDX) for the TD architecture. The TD architecture provides isolation between TD workloads 190A-190C and from CSP software (e.g., TDRM 180 and/or a CSP VMM (e.g., root VMM 180)) executing on the processor 112). Components of the TD architecture can include 1) memory encryption via MK-TME engine 145, 2) a resource management capability referred to herein as the TDRM 180, and 3) execution state and memory isolation capabilities in the processor 112 provided via a MOT 160 and via access-controlled TD control structures (i.e., TDCS 124 and TDTCS 128). The TDX architecture provides an ability of the processor 112 to deploy TDs 190A-190C that leverage the MK-TME engine 145, the MOT 160, and the access-controlled TD control structures (i.e., TDCS 124 and TDTCS 128) for secure operation of TD workloads 190A-190C.

In implementations of the disclosure, the TDRM 180 acts as a host and has full control of the cores 120 and other platform hardware. A TDRM 180 assigns software in a TD 190A-190C with logical processor(s). The TDRM 180, however, cannot access a TD's 190A-190C execution state on the assigned logical processor(s). Similarly, a TDRM 180 assigns physical memory and I/O resources to the TDs 190A-190C, but is not privy to access the memory state of a TD 190A due to separate encryption keys, and other integrity and replay controls on memory.

With respect to the separate encryption keys, the processor may utilize the MK-TME engine 145 to encrypt (and decrypt) memory used during execution. With total memory encryption (TME), any memory accesses by software executing on the core 120 can be encrypted in memory with an encryption key. MK-TME is an enhancement to TME that allows use of multiple encryption keys (the number of supported keys is implementation dependent). The processor 112 may utilize the MKTME engine 145 to cause different pages to be encrypted using different MK-TME keys. The MK-TME engine 145 may be utilized in the TD architecture described herein to support one or more encryption keys per each TD 190A-190C to help achieve the cryptographic isolation between different CSP customer workloads. For example, when MK-TME engine 145 is used in the TD architecture, the CPU enforces by default that TD (all pages) are to be encrypted using a TD-specific key. Furthermore, a TD may further choose specific TD pages to be plain text or encrypted using different ephemeral keys that are opaque to CSP software.

Each TD 190A-190C is a software environment that supports a software stack consisting of VMMs (e.g., using virtual machine extensions (VMX)), OSes, and/or application software (hosted by the OS). Each TD 190A-190C operates independently of other TDs 190A-190C and uses logical processor(s), memory, and I/O assigned by the TDRM 180 on the platform. Software executing in a TD 190A-190C operates with reduced privileges so that the TDRM 180 can retain control of platform resources; however, the TDRM cannot affect the confidentiality or integrity of the TD 190A-190C under defined circumstances. Further details of the TD architecture and TDX are described in more detail below with reference to FIG. 1B.

Implementations of the disclosure are not limited to computer systems. Alternative implementations of the disclosure can be used in other devices such as handheld devices and embedded applications. Some examples of handheld devices include cellular phones, Internet Protocol devices, digital cameras, personal digital assistants (PDAs), and handheld PCs. Embedded applications can include a micro controller, a digital signal processing device (DSP), system on a chip, network computers (NetPC), set-top boxes, network hubs, wide area network (WAN) switches, or any other system that can perform one or more instructions in accordance with at least one implementation.

One implementation may be described in the context of a single processing device desktop or server system, but alternative implementations may be included in a multiprocessing device system. Computing system 100 may be an example of a ‘hub’ system architecture. The computing system 100 includes a processor 112 to process data signals. The processor 112, as one illustrative example, includes a complex instruction set computer (CISC) micro-processing device, a reduced instruction set computing (RISC) micro-processing device, a very long instruction word (VLIW) micro-processing device, a processing device implementing a combination of instruction sets, or any other processing device, such as a digital signal processing device, for example. The processor 112 is coupled to a processing device bus that transmits data signals between the processor 112 and other components in the computing system 100, such as main memory 114 and/or secondary storage 118, storing instruction, data, or any combination thereof. The other components of the computing system 100 may include a graphics accelerator, a memory controller hub, an I/O controller hub, a wireless transceiver, a Flash BIOS, a network controller, an audio controller, a serial expansion port, an I/O controller, etc. These elements perform their conventional functions that are well known to those familiar with the art.

In one implementation, processor 112 includes a Level 1 (L1) internal cache memory. Depending on the architecture, the processor 112 may have a single internal cache or multiple levels of internal caches. Other implementations include a combination of both internal and external caches depending on the particular implementation and needs. A register file is to store different types of data in various registers including integer registers, floating point registers, vector registers, banked registers, shadow registers, checkpoint registers, status registers, configuration registers, and instruction pointer register.

It should be noted that the execution unit may or may not have a floating point unit. The processor 112, in one implementation, includes a microcode (ucode) ROM to store microcode, which when executed, is to perform algorithms for certain macroinstructions or handle complex scenarios. Here, microcode is potentially updateable to handle logic bugs/fixes for processor 112.

Alternate implementations of an execution unit may also be used in micro controllers, embedded processing devices, graphics devices, DSPs, and other types of logic circuits. System 100 includes a main memory 114 (may also be referred to as memory 114). Main memory 114 includes a DRAM device, a static random-access memory (SRAM) device, flash memory device, or other memory device. Main memory 114 stores instructions and/or data represented by data signals that are to be executed by the processor 112. The processor 112 is coupled to the main memory 114 via a processing device bus. A system logic chip, such as a memory controller hub (MCH) may be coupled to the processing device bus and main memory 114. An MCH can provide a high bandwidth memory path to main memory 114 for instruction and data storage and for storage of graphics commands, data and textures. The MCH can be used to direct data signals between the processor 112, main memory 114, and other components in the system 100 and to bridge the data signals between processing device bus, memory 114, and system I/O, for example. The MCH may be coupled to memory 114 through a memory interface. In some implementations, the system logic chip can provide a graphics port for coupling to a graphics controller through an Accelerated Graphics Port (AGP) interconnect.

The computing system 100 may also include an I/O controller hub (ICH). The ICH can provide direct connections to some I/O devices via a local I/O bus. The local I/O bus is a high-speed I/O bus for connecting peripherals to the memory 114, chipset, and processor 112. Some examples are the audio controller, firmware hub (flash BIOS), wireless transceiver, data storage, legacy I/O controller containing user input and keyboard interfaces, a serial expansion port such as Universal Serial Bus (USB), and a network controller. The data storage device can comprise a hard disk drive, a floppy disk drive, a CD-ROM device, a flash memory device, or other mass storage device.

For another implementation of a system, the instructions executed by the processing device core 120 described above can be used with a system on a chip. One implementation of a system on a chip comprises of a processing device and a memory. The memory for one such system is a flash memory. The flash memory can be located on the same die as the processing device and other system components. Additionally, other logic blocks such as a memory controller or graphics controller can also be located on a system on a chip.

With reference to FIG. 1B, this figure depicts a block diagram of the processor 112 of FIG. 1A, according to one implementation of the disclosure. In one implementation, the processor 112 may execute an application stack 101 via a single core 120 or across several cores 120. As discussed above, the processor 112 may provide a TD architecture and TDX to provide confidentiality (and integrity) for customer software running in the customer/tenants (i.e., TDs 190A) in an untrusted cloud service providers (CSP) infrastructure. The TD architecture provides for memory isolation via a MOT 160; CPU state isolation that incorporates CPU key management via TDCS 124 and/or TDTCS 128; and CPU measurement infrastructure for TD 190A software.

In one implementation, TD architecture provides ISA extensions (referred to as TDX) that support confidential operation of OS and OS-managed applications (virtualized and non-virtualized). A platform, such as one including processor 112, with TDX enabled can function as multiple encrypted contexts referred to as TDs. For ease of explanation, a single TD 190A is depicted in FIG. 1B. Each TD 190A can run VMMs, VMs, OSes, and/or applications. For example, TD 190A is depicted as hosting VM 195A.

In one implementation, the TDRM 180 may include as part of VMM functionality (e.g., root VMM). A VMM may refer to software, firmware, or hardware to create, run, and manage a virtual machines (VM), such as VM 195A. It should be noted that the VMM may create, run, and manage one or more VMs. As depicted, the VMM 110 is included as a component of one or more processing cores 120 of a processing device 122. The VMM 110 may create and run the VM 195A and allocate one or more virtual processors (e.g., vCPUs) to the VM 195A. The VM 195A may be referred to as guest 195A herein. The VMM may allow the VM 195A to access hardware of the underlying computing system, such as computing system 100 of FIG. 1A. The VM 195A may execute a guest operating system (OS). The VMM may manage the execution of the guest OS. The guest OS may function to control access of virtual processors of the VM 195A to underlying hardware and software resources of the computing system 100. It should be noted that, when there are numerous VMs 195A operating on the processing device 112, the VMM may manage each of the guest OSes executing on the numerous guests. In some implementations, a VMM may be implemented with the TD 190A to manage the VMs 195A. This VMM may be referred to as a tenant VMM and/or a non-root VMM and is discussed in further detail below.

TDX also provides a programming interface for a TD management layer of the TD architecture referred to as the TDRM 180. A TDRM may be implemented as part of the CSP/root VMM. The TDRM 180 manages the operation of TDs 190A. While a TDRM 180 can assign and manage resources, such as CPU, memory and input/output (I/O) to TDs 190A, the TDRM 180 is designed to operate outside of a TCB of the TDs 190A. The TCB of a system refers to a set of hardware, firmware, and/or software component that have an ability to influence the trust for the overall operation of the system.

In one implementation, the TD architecture is thus a capability to protect software running in a TD 190A. As discussed above, components of the TD architecture may include 1) Memory encryption via a TME engine having Multi-key extensions to TME (e.g., MK-TME engine 145 of FIG. 1A), 2) a software resource management layer (TDRM 180), and 3) execution state and memory isolation capabilities in the TD architecture.

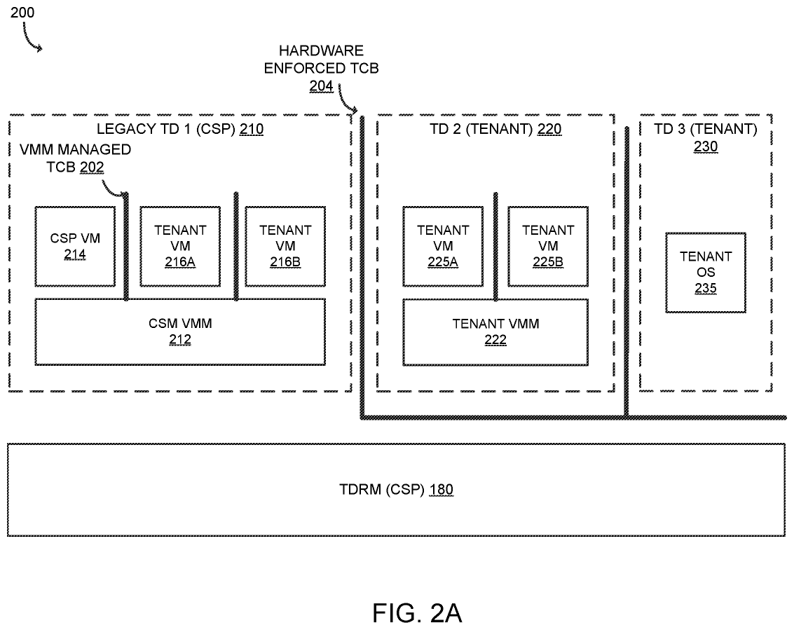

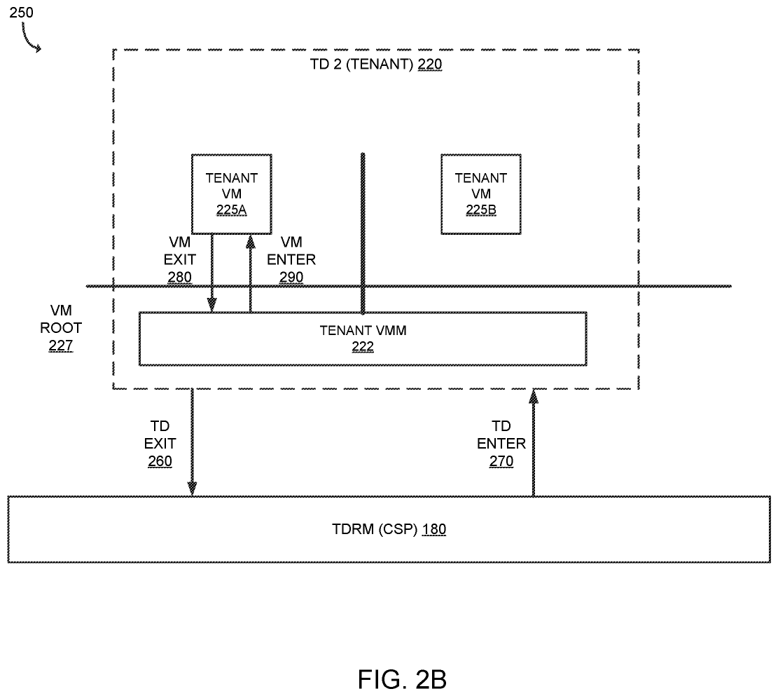

FIG. 2A is a block diagram depicting an example computing system implementing TD architecture 200. The TD architecture 200 supports two types of TDs. A first type of TD is a TD where the tenant trusts the CSP to enforce confidentiality and does not implement the TD architecture of implementations of the disclosure. This type of legacy TD is depicted as TD 1 210. TD 1 210 is a CSP TD having a CSP VMM-managed TCB 202. TD 1 210 may include a CSP VMM 212 managing a CSP VM 214 and/or one or more tenant VMs 216A, 216B. In this case, the tenant VMs 216A, 216B are managed by the CSP VMM 212 that is in the VM's 216A, 216B TCB 202. In implementations of the disclosure, the tenant VMs 216A, 216B may still leverage memory encryption via TME or MK-TME in this model (described further below).

The other type of TD is a TD is a TD where the tenant does not trust the CSP to enforce confidentiality and thus relies on the CPU with TD architecture of implementations of the disclosure. This type of TD is shown in two variants as TD2 220 and TD3 230. The TD2 220 is shown with a virtualization mode (such as VMX) being utilized by the tenant VMM (non-root) 222 running in TD2 220 to managed tenant VMs 225A, 225B. The TD3 230 does not include software using a virtualization mode, but instead runs an enlightened OS 235 in the TD3 230 directly. TD2 220 and TD3 230 are tenant TDs having a hardware enforced TCB 204 as described in implementations of the disclosure. In one implementation, TD2 220 or TD3 230 may be the same as TD 190A described with respect to FIGS. 1A and/or FIG. 1B.

The TDRM 180 manages the life cycle of all three types of TDs 210, 220, 230, including allocation of resources. However, the TDRM 180 is not in the TCB for TD types TD2 220 and TD3 230. The TD architecture 200 does not place any architectural restrictions on the number or mix of TDs active on a system. However, software and certain hardware limitations in a specific implementation may limit the number of TDs running concurrently on a system due to other constraints.

FIG. 2B is a block diagram depicting an example of a TD architecture 250 and the interactions between a TD 220 and TDRM 280. In one implementation, TD 220 and TDRM 280 are the same as their counterparts described with respect to FIG. 2A. The TD architecture 250 may be the same as a TD architecture provided by computing device 100 of FIGS. 1A and 1B, and/or TD architecture 200 of FIG. 2A. TD architecture 250 provides a layer that manages lifecycle of TDs active on a system. Processor support for TDs is provided by a form of processor operation called a TDX operation. There are two kinds of TDX operations: a Resource Manager operation and a Tenant operation. In general, the TDRM 180 runs in TDX Resource Manager operation and TDs, such as TD2 220, run in TDX Tenant operation. Transitions between Resource-Manager operation and Tenant operation are called TDX transitions.

There are two kinds of TDX transitions: TD entry 270 and TD exit 260. Transitions from TDX Resource-Manager operation into TDX Tenant operation are called TD entries 270. Transitions from TDX Tenant operation to TDX Resource Manager operation are called TD exits 260.

Processor behavior in TDX Resource-Manager operation is similar as it is outside of TDX operation. The principal differences are that a set of TDX operations (TDX instructions) is available and that values that can be loaded into certain control registers are limited to restrict the modes and abilities of the TDRM 180.

Processor behavior in TDX Tenant operation is similarly restricted to facilitate isolation. For example, instead of ordinary operation, certain events cause TD exits 260 to the TDRM 180. These TD exits 260 do not allow the TDRM 180 to modify TD 220 behavior or state. The TDRM 180 uses platform capabilities to retain control of platform resources. Software running in a TD 220 may use software-visible information to determine it is running in a TD 220, and may enforce local measurement policies on additional software loaded into the TD 220. However, validating the security state of the TD 220 is performed by a remote attestation party to ensure confidentiality.

The TD architecture 250 is designed to minimize compatibility impact on software that relies on virtualization when running in a TD 220, and therefore, leaves most interactions between a VM 225A, 225B running in Tenant operation and a Tenant VMM 222 running in Tenant operation unchanged. If there is no VMM 222 present in a TD 220, a VM OS may be modified to work with TDRM 180 as the root VMM.

In one implementation, the TDRM 180 may explicitly decide to cause a TD exit 260, for example, to terminate a TD 120 or to manage memory resources (e.g., yield assigned memory resource, request free memory resources, etc.). The TD architecture 250 also provides the TDRM 180 with the ability to force TD exits 260 for preemption. On TD exits 260, the TD architecture enforces that the execution state of a TD 220 is saved in CPU access-controlled memory allocated to the TD 220 and encrypted using a unique encryption key (discussed further below) of the TD 220 that is not visible to TDRM 180 or other TDs to protect confidentiality of TD state from the TDRM 180 or other TDs. The TD execution state may similarly be protected against spoofing, remapping and/or replay via integrity controls on memory.

TD enter 270 is a complementary event to TD exit 260. For example, a TD enter 270 may occur when the TDRM 180 schedules a TD 220 to run on a logical processor and transfers execution to the software running in the TD 220. During TD enter 270, the TD architecture 250 enforces that the execution state of the TDRM 180 is saved in memory owned by the TDRM, which is encrypted using a unique encryption key assigned for sole use by the TDRM 180.

TDs, such as TD 220, can be set up by the TDRM 180 using a TDCREATE (to create TDCS), TDTCREATE (to create TD-TCS) and TDADDPAGE instructions that causes memory belonging to a TD 220 to be encrypted using the TD's unique encryption key that is not visible or accessible to the TDRM 180 or other TDs. Before executing any instructions belonging to a TD, all TD memory is encrypted using the TD's unique key. Although specific instruction names are referenced herein, other names for the instructions may be utilized in implementations of the disclosure and are not limited to the specific names provided herein.

In one implementation, the TDRM 180 can launch each TD 220 with a small software image (similar to IBB or Initial Boot Block) after signature verification and record the IBB measurements (for subsequent attestation) using a platform root of trust. It is the IBB software executing in the TD 220 that is responsible for completing the measured launch of the TD 220 and requesting additional resources from the TDRM 180. The TD 220 has the option to use a single encryption key for the entire TD 220 or use additional encryption keys for different Tenant VMs 225A, 225B (and/or containers or different memory resources such as NVRAM) when running inside the TD 220. Thus, when the TD 220 is first set up, the TD 220 is using an exclusive CPU-generated MK-TME key. Thereafter, the TD 220 may optionally set up additional MK-TME encryption keys for each tenant software-managed context that operates inside the TD 220 (e.g., tenant VMs 225A, 225B, containers or other memory types).

In order to minimize software compatibility impact on VMMs both for CSP (e.g., TDRM root VMM 180 and tenant VMM 222), virtualization (e.g., VMX) operation may remain unmodified inside a TD 220 in TD architecture 250. Similarly, operation of VMM software, such as extended page table (EPT) management, can remain under the control of the tenant VMM 222 (if one is active in the TD 220 and is not managed by the TDRM 180). As the TDRM 180 assigns physical memory for each TD 220, the TD architecture 250 includes the MOT (i.e., MOT 160 described with respect to FIGS. 1A and 1B). The processor 112 consults the TDRM 180-managed MOT to assign allocation of memory to TDs 220. This allows the TDRM 180 the full ability to manage memory as a resource without having any visibility into data resident in assigned TD memory. In some implementations, as discussed above, the platform (e.g., root) VMM and TDRM 180 may be in the same encryption key domain, thus sharing the memory management and scheduler functions (but still remaining outside the Tenant's TCB).

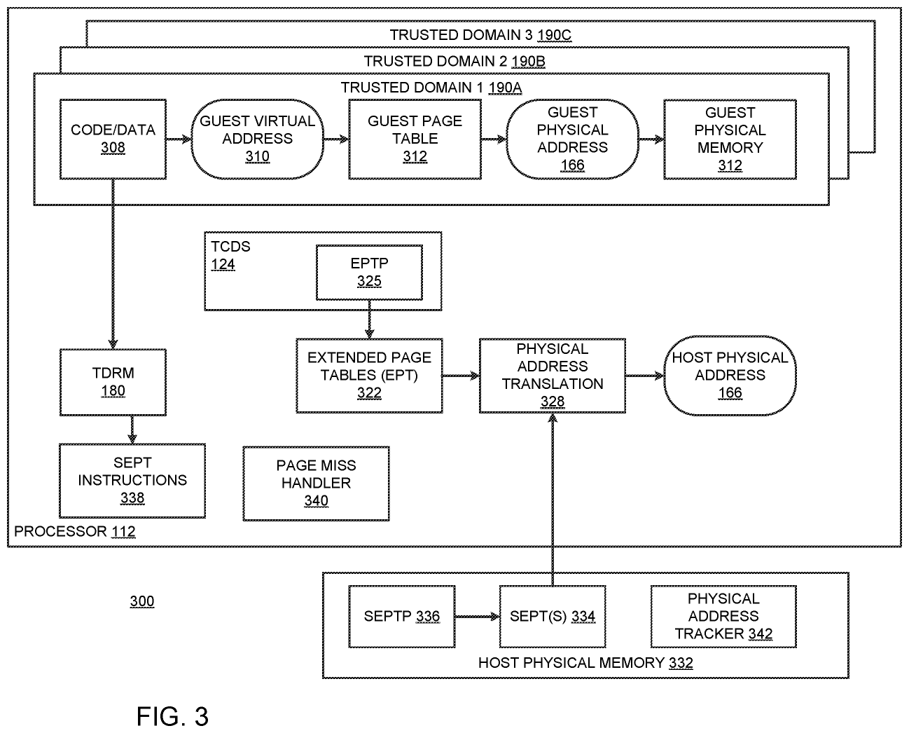

In an embodiment, FIG. 3 illustrates an example computing system 300. One or more Trusted Domains (TDs) from TD 1 190A, TD 2 190B, TD N 190C, where N is a natural number, may be instantiated on computing system 300. Each TD includes code/data 308, which may include references to one or more guest virtual addresses (GVAs) 310. To translate a GVA into a physical address that can be used to access a portion of the computing system's physical memory, a TD may use guest page table 312. Thus, GVA 310 may be translated using guest page table 312 to guest physical address (GPA) 166. GPA 166 may then be mapped to a host physical address (HPA) 161 via EPTs 322, to access host physical memory 332.

South Cove (aka TDXIO) is a technology which allows a trusted device to read and write directly into a TD's memory. In a TDXIO environment, a TD attests the device and if successful, programs link encryption key in the device's PCIe interface and in the PCIe rootport on a system-on-chip (SoC). The TD also programs a Trusted Table in the input/output memory management unit (IOMMU) with direct memory access (DMA) page translations and device ID to allow device to access TD's memory directly. During a DMA transfer from the device to the TD, data is encrypted in the PCIe interface as it leaves the device. It is decrypted at the rootport on the SoC. The IOMMU checks if the device is allowed to access TD memory and performs the translations using the Trusted table. Data coming from the device is written into TD's private memory. Thus, while existing TDXIO solutions control a remote device's access into a TD's private memory via a trusted table in the IOMMU which ensures that only devices authorized by TD are allowed to access TD's private memory, it doesn't have finer grain control on which memory within TD a device can access.

Subject matter described herein address these and other issues by defining separate IO pages within a TD where device is allowed to read and write. A device that is exploited (e.g., by an attacker) can corrupt or leak IO data from the IO pages in the TD to which it has access but cannot access to rest of TD's sensitive data. This effectively elevates the device to the same level of trust as the CPU by allowing device direct access to TD's memory. In technologies like SGX, which have a limited amount of SGX memory, this invention effectively increases the size of memory that SGX enclaves can access securely.

By way of overview, in some examples a TEE (e.g., TD, SGX enclave, etc.) allocates IO pages and stores information about the IO pages in a data structure referred to herein as an Input/Output Control Structure (IOCS). The TEE then programs the IOMMU to allow access to the IO page tables by mapping IO ranges using entries in CPU-protected memory as an extra-level PTE (Page Table Entry). The IOCS keeps track of IO pages and is stored in CPU-protected memory (e.g., EPC or encrypted with TD private key). In some examples, IO pages are 4 KB pages and the number of pages allocated is arbitrary, determined by the TEE.

In some examples the IOCS fields include an IO range, which may be enumerated by an input/output virtual address (IOVA), a guest physical address (GPA) and a host physical address (HPA), a PENDING bit, device identifier (DEV_ID), and a pointer to a TEE Control Structure (e.g., TDCS, SECS) to verify that the IO range belongs to the TEE.

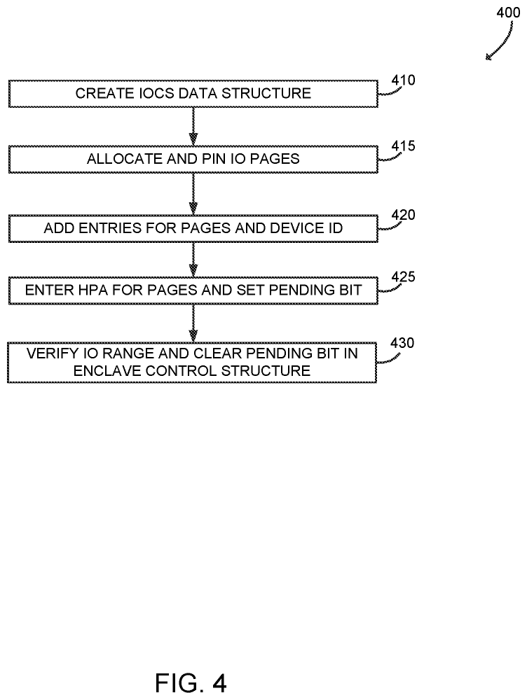

In some examples the IOCS may be constructed when the TEE is created and/or launched, or it may get created when the DMA buffer request is made for the first time. The OS may use ISA extensions, as described below, to create IOCS pages and to populate IOCS entries. When a new entry is created, the CPU translates IOVA to GPA and HPA (if applicable) and records them in the IOCS entry. The OS pins the pages for DMA. HPA from PT/EPT points to an entry in IOCS. The TEE accepts new entries by verifying the contents and clearing the pending bit. Additional details are described below with reference to FIGS. 4-7.

### Setup

FIG. 4 is a simplified flow diagram of at least one embodiment of a method to provide fine grained access into private memory of a trusted execution environment, in accordance with some embodiments. More particularly, FIG. 4 depicts operations implemented during a setup process. Referring to FIG. 4, at operation 410 an input/output control structure (IOCS) data structure is created. In some examples the operating system may create an input/output control structure (IOCS) data structure when the TEE is launched by invoking a function referred to herein as IOSCREATE. In some examples, the IOSCREATE function may be incorporated into an instruction set architecture (ISA). When invoked, the IOSCREATE function creates the input/output control structure (IOCS) data structure that contains IO pages and device access information. The IOSCREATE function may be invoked either when the TEE is first launched or upon request by the TEE. The input/output control structure (IOCS) data structure is created in protected memory.

At operation 415 IO pages are allocated and pinned. In some examples the operating system (OS) adds and pins the pages. In some examples, the TEE requests the operating system (OS) to allocate pages for the device identified by the DEVICE_ID. In response, the operating system (OS) allocates and pins the pages.

At operation 420 entries for the pages and the device identified by the DEVICE_ID are added to the input/output control structure (IOCS) data structure. In some examples the operating system invokes a function referred to herein as the IOCREATE function to add an entry for the pages and the device identified by the DEVICE_ID. In some examples, the IOCREATE function may be incorporated into an instruction set architecture (ISA).

At operation 425 the HPA for the pages is entered and a pending bit is set. In some examples, the operating system (OS) enters the HPA for the IO pages and sets a pending bit to a value that indicates that the device identified by the DEVICE_ID cannot access the pages such that no IO transactions can take place.

At operation 430 the IO range for the device identified by the DEVICE_ID is verified and, upon verification, the PENDING bit is set to a value that indicates that the device identified by the DEVICE_ID is permitted to access the IO pages. In some examples the CPU verifies the IO range. In some examples, the TEE invokes a function referred to herein as the IOACCEPT function to clear the PENDING bit. In some examples, the IOACCEPT function may be incorporated into an instruction set architecture (ISA).

### DMA Transfer

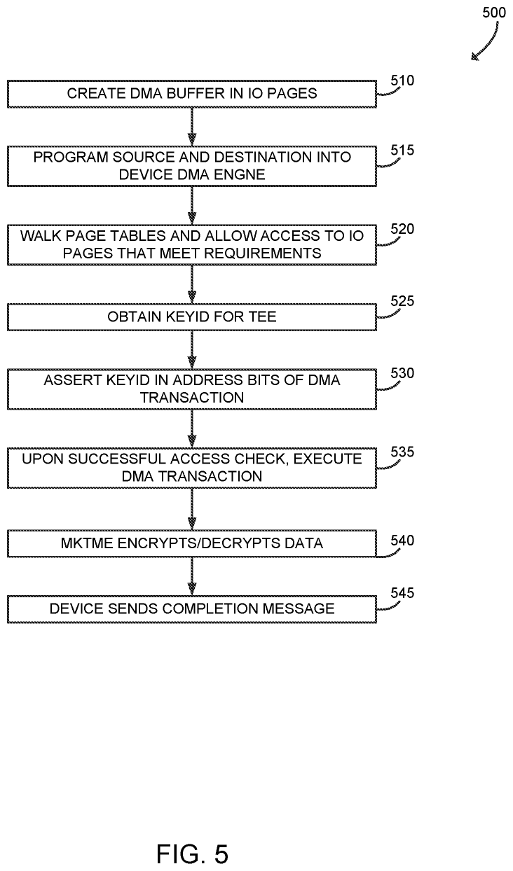

FIG. 5 is a simplified flow diagram of at least one embodiment of a method to provide fine grained access into private memory of a trusted execution environment, in accordance with some embodiments. More particularly, FIG. 5 depicts operations implemented during a DMA transfer process. Referring to FIG. 5, at operation 510 a DMA buffer is created in the IO page(s) allocated in the operations of FIG. 4, and at operation 515 source address(es) and destination address(es) are programmed into a DMA engine. In some examples, the TEE creates the DMA buffer and programs the DMA engine with the assistance of a device driver. In some examples, the device identified by the DEVICE_ID issues one or more DMA transactions. Data in PCIe packets is encrypted on the communication link, e.g., using integrity and data encryption (IDE) techniques, and is decrypted when it arrives at the rootport of a system-on-chip (SOC).

At operation 520 a page table walk operation is implemented to walk the page tables and allow access to IO pages that meet the requirements. In some examples access to the IO pages is allowed if the following criteria are met. First, the HPA must point to an input/output control structure (IOCS) entry. Second, the HPA must be within the IO range accessible to the device identified by the DEVICE_ID. If the device uses IOVA or GPA, these are translated to HPA using trusted translation tables. Third, the DEVICE_ID must match the DEVICE_ID in the input/output control structure (IOCS) entry. Fourth, the PENDING bit must be set to a value which indicates that the device identified by the DEVICE_ID is permitted to access the IO pages. In some examples the PENDING bit is set to zero.

At operation 520 the KEY_ID for the TEE is obtained. In some examples the device looks up the KEY_ID for the TEE and, at operation 530, asserts the KEY_ID in the address bit of the DMA transaction.

At operation 535, upon a successful access check, the DMA transaction is executed. The DMA transaction is committed to memory. In some examples, at operation 540, an encryption circuitry such as an MKTME circuit will encrypt the data (for a write transaction) or decrypt the data (for a read transaction).

At operation 545, the device identified the by DEVICE_ID sends a completion message to the driver which, in turn notifies the TEE that the DMA transaction is complete.

### Teardown

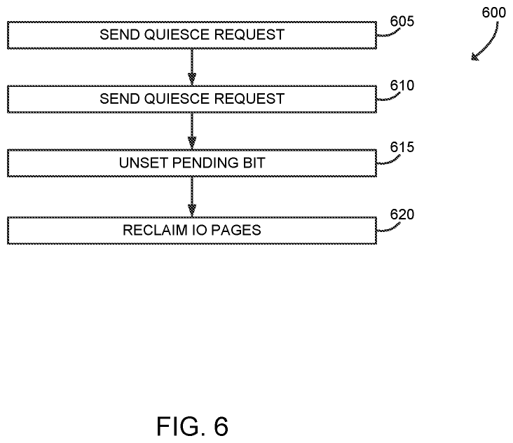

FIG. 6 is a simplified flow diagram of at least one embodiment of a method to provide fine grained access into private memory of a trusted execution environment, in accordance with some embodiments. More particularly, FIG. 6 depicts operations implemented during a teardown process. Referring to FIG. 6, at operation 605 the PENDING bit is set to a value which indicates that the device identified by the DEVICE_ID is permitted to access the IP pages. At operation 610, a TEE may send a quiesce request to the device identified by the DEVICE_ID if the TEE does not want the device to access the IO pages anymore.

At operation 615 the PENDING bit is set to a value which indicates that the device identified by the DEVICE_ID is not permitted to access the 10 pages. In some examples, the TEE may invoke the IOACCEPT instruction to set the PENDING bit.

At operation 620, in some examples, the TEE may want to reclaim the IO pages allocated in the operations of FIG. 4. In some examples the TEE may call the OS to remove the IO pages. The OS may invoke a function referred to herein as the IOREMOVE function to remove the pages from the input/output control structure (IOCS). In some examples, the IOREMOVE function may be incorporated into an instruction set architecture (ISA).

### Page Walk

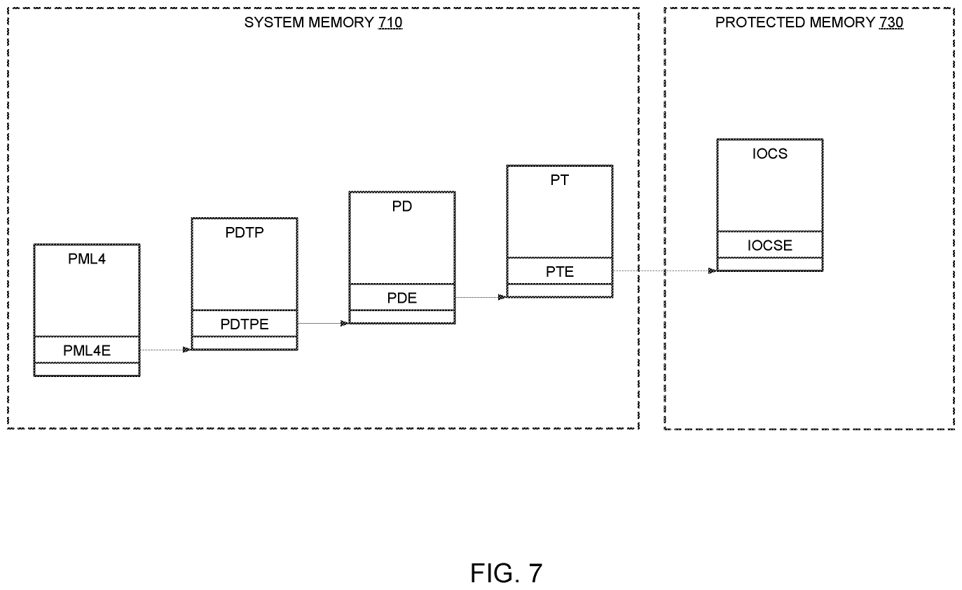

FIG. 7 illustrates steps in a page table walk, in accordance with embodiments. Referring to FIG. 7, in some examples the page-table walk results may depend on access semantics if the physical address (PA) in a page table entry (PTE) (i.e., the host physical address (HPA) in an extended page table entry (EPTE) points in system memory 710 to an entry in an IOCS page, which is in CPU-protected memory 730 (e.g., SGX EPC or TD private memory).

For enclave access (e.g., a linear address (LA) in the enclave liner address range (ELRANGE)) or TD access (e.g., GPA.SHARED=0), the CPU checks the enclave page cache metadata (EPCM) structure and determines the target page is of IOCS type. In in case of TD, there is a bit in EPTE that indicates that. The CPU then checks if IOCS entry belongs to TEE via the back pointer. The CPU then retrieves the final HPA from the IOCS entry.

For non-enclave access or non-TD access, the CPU doesn't abort the access right away. Instead, it checks the EPCM entry to determine if the access can continue (i.e., is the access to an IOCS page) or in case of TD, a bit in EPTE. The CPU then checks if IOCS entry belongs to TEE via the back pointer. Finally, the CPU retrieves the final HPA from the IOCS entry.

In some examples the functions described above may be incorporate into an instruction set, as follows.

IOCSCREATE: This instruction may be called by operating system to create the data structure that contains IO pages and device access information. This may be created when the TEE is first launched or upon request from the TEE. The instruction creates IOCS in CPU-protected memory 730.

IOCREATE: instruction may be called by operating system after TEE requests allocation of IO pages for a given device. The TEE will provide IOVA or GPA, size or range and DEV_ID. OS allocates the pages and then adds information in the IOCS via IOCREATE. The instruction creates an entry in IOCS, inserts TEE_ID, IO range, DEV_ID, and sets PENDING bit.

IOACCEPT: This instruction clears or sets the pending bit based on the flag. Once IO pages have been created and IOCS entry has been added, the TEE invokes IOACCEPT to clear the pending bit. The CPU walks page tables depicted in FIG. 7 and verifies IO range, TEE_ID, DEV_ID and checks if the IORANGE does not overlap with TEE's memory. It then clears the pending bit allowing device with the given DEV_ID to access these pages. If the TEE wants to remove access for the device, it will invoke IOACCEPT with a flag that will set the pending bit on. The device may no longer be able to read or write to these pages.

IOREMOVE: When TEE is done with the IO pages, it sets the pending bit again and then calls the OS to remote IO pages. OS will invoke IOREMOVE to remove the entry for these pages from IOCS.

Illustrative examples of the technologies disclosed herein are provided below. An embodiment of the technologies may include any one or more, and any combination of, the examples described below.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Embodiments may be provided, for example, as a computer program product which may include one or more transitory or non-transitory machine-readable storage media having stored thereon machine-executable instructions that, when executed by one or more machines such as a computer, network of computers, or other electronic devices, may result in the one or more machines carrying out operations in accordance with embodiments described herein. A machine-readable medium may include, but is not limited to, floppy diskettes, optical disks, CD-ROMs (Compact Disc-Read Only Memories), and magneto-optical disks, ROMs, RAMs, EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

Some embodiments pertain to Example 1 that includes an apparatus comprising a hardware processor to create an input/output control data structure (IOCS) for a trusted execution environment (TEE); allocate an input/output (I/O) address range comprising a host physical address (HPA) and a plurality of input/output (IO) pages to the input/output control structure; create an entry in the input/output control structure (IOCS) for a set of input/output (IO) pages and a device identifier for a remote device; set a pending bit to a first value which indicates that the remote device is authorized to access the input/output (I/O) address range; and grant the remote device access to the set of input/output pages in the input/output control structure upon verification of an input/output (IO) address range for the remote device.

Example 2 includes the subject matter of Example 1, the hardware processor to convert an input/output virtual address (IOVA) tot least one of a guest physical address (GPA) or a host physical address (HPA).

Example 3 includes the subject matter of Examples 1 and 2, the hardware processor to create a direct memory access (DMA) buffer in the set of input/output pages; and program a direct memory access (DMA) circuitry with a source address and a destination address for a direct memory access (DMA) transfer between the device and the trusted execution environment (TEE).

Example 4 includes the subject matter of Examples 1-3, the processor to receive the direct memory access (DMA) transfer comprising encrypted data; and decrypt the encrypted data.

Example 5 includes the subject matter of Examples 1-4, the hardware processor to allow the direct memory access (DMA) transfer to access secure memory in the input/output address (IO) range for the remote device in response to a determination that the remote device is authorized to access the input/output (I/O) address range.

Example 6 includes the subject matter of Examples 1-5, the hardware processor to retrieve an encryption key identifier (KEY_ID) for the trusted execution environment (TEE); and assert the encryption key identifier (KEY_ID) in address bits of the direct memory access (DMA) transfer.

Example 7 includes the subject matter of Examples 1-6, the hardware processor to receive a request from the trusted execution environment (TEE) to terminate access by the remote device to the input/output (I/O) address range; and set the pending bit to a second value which indicates that the remote device is not authorized to access the input/output (I/O) address range.

Some embodiments pertain to Example 8 that includes a processor implemented method comprising creating an input/output control data structure (IOCS) for a trusted execution environment (TEE); allocating an input/output (I/O) address range comprising a host physical address (HPA) and a plurality of input/output (IO) pages to the input/output control structure; creating an entry in the input/output control structure (IOCS) for a set of input/output (IO) pages and a device identifier for a remote device; setting a pending bit to a first value which indicates that the remote device is authorized to access the input/output (I/O) address range; and granting the remote device access to the set of input/output pages in the input/output control structure upon verification of an input/output (IO) address range for the remote device.

Example 9 includes the subject matter of Example 8, further comprising converting an input/output virtual address (IOVA) tot least one of a guest physical address (GPA) or a host physical address (HPA).

Example 10 includes the subject matter of Examples 8 and 9, further comprising creating a direct memory access (DMA) buffer in the set of input/output pages; and programing a direct memory access (DMA) circuitry with a source address and a destination address for a direct memory access (DMA) transfer between the device and the trusted execution environment (TEE).

Example 11 includes the subject matter of Examples 8-10, further comprising receiving the direct memory access (DMA) transfer comprising encrypted data; and decrypting the encrypted data.

Example 12 includes the subject matter of Examples 8-11, further comprising allowing the direct memory access (DMA) transfer to access secure memory in the input/output address (IO) range for the remote device in response to a determination that the remote device is authorized to access the input/output (I/O) address range.

Example 13 includes the subject matter of Examples 8-12, further comprising retrieving an encryption key identifier (KEY_ID) for the trusted execution environment (TEE); and asserting the encryption key identifier (KEY_ID) in address bits of the direct memory access (DMA) transfer.

Example 14 includes the subject matter of Examples 8-13, further comprising receiving a request from the trusted execution environment (TEE) to terminate access by the remote device to the input/output (I/O) address range; and setting the pending bit to a second value which indicates that the remote device is not authorized to access the input/output (I/O) address range.

Some embodiments pertain to Example 15, that includes at least one non-transitory computer readable medium having instructions stored thereon, which when executed by a processor, cause the processor to create an input/output control data structure (IOCS) for a trusted execution environment (TEE); allocate an input/output (I/O) address range comprising a host physical address (HPA) and a plurality of input/output (IO) pages to the input/output control structure; create an entry in the input/output control structure (IOCS) for a set of input/output (IO) pages and a device identifier for a remote device; set a pending bit to a first value which indicates that the remote device is authorized to access the input/output (I/O) address range; and grant the remote device access to the set of input/output pages in the input/output control structure upon verification of an input/output (IO) address range for the remote device.

Example 16 includes the subject matter of Example 15, comprising instructions which, when executed by processor, cause the processor to convert an input/output virtual address (IOVA) tot least one of a guest physical address (GPA) or a host physical address (HPA).

Example 17 includes the subject matter of Examples 15 and 16, comprising instructions which, when executed by processor, cause the processor to create a direct memory access (DMA) buffer in the set of input/output pages; and program a direct memory access (DMA) circuitry with a source address and a destination address for a direct memory access (DMA) transfer between the device and the trusted execution environment (TEE).

Example 18 includes the subject matter of Examples 15-17, further comprising instructions which, when executed by processor, cause the processor to receive the direct memory access (DMA) transfer comprising encrypted data; and decrypt the encrypted data.

Example 19 includes the subject matter of Examples 15-18, further comprising instruction which, when executed by processor, cause the processor to allow the direct memory access (DMA) transfer to access secure memory in the input/output address (IO) range for the remote device in response to a determination that the remote device is authorized to access the input/output (I/O) address range.

Example 20 includes the subject matter of Examples 15-19, further comprising instruction which, when executed by processor, cause the processor to retrieve an encryption key identifier (KEY_ID) for the trusted execution environment (TEE); and assert the encryption key identifier (KEY_ID) in address bits of the direct memory access (DMA) transfer.

Example 21 includes the subject matter of Examples 15-20, further comprising instruction which, when executed by processor, cause the processor to receive a request from the trusted execution environment (TEE) to terminate access by the remote device to the input/output (I/O) address range; and set the pending bit to a second value which indicates that the remote device is not authorized to access the input/output (I/O) address range.

The details above have been provided with reference to specific embodiments. Persons skilled in the art, however, will understand that various modifications and changes may be made thereto without departing from the broader spirit and scope of any of the embodiments as set forth in the appended claims. The foregoing description and drawings are, accordingly, to be regarded in an illustrative rather than a restrictive sense.

What is claimed is:

1. An apparatus, comprising:
a hardware processor to:
create an input/output control data structure (IOCS) for a trusted execution environment (TEE);
allocate an input/output (I/O) address range comprising a host physical address (HPA) and a plurality of input/output (IO) pages to the input/output control structure;
create an entry in the input/output control structure (IOCS) for a set of input/output (IO) pages and a device identifier for a remote device;
set a pending bit to a first value which indicates that the remote device is authorized to access the input/output (I/O) address range; and
grant the remote device access to the set of input/output pages in the input/output control structure upon verification of an input/output (IO) address range for the remote device.

2. The apparatus of claim 1, the hardware processor to:
convert an input/output virtual address (IOVA) tot least one of a guest physical address (GPA) or a host physical address (HPA).

3. The apparatus of claim 1, the hardware processor to:
create a direct memory access (DMA) buffer in the set of input/output pages; and
program a direct memory access (DMA) circuitry with a source address and a destination address for a direct memory access (DMA) transfer between the device and the trusted execution environment (TEE).

4. The apparatus of claim 3, the hardware processor to:
receive the direct memory access (DMA) transfer comprising encrypted data; and
decrypt the encrypted data.

5. The apparatus of claim 4, the hardware processor to:
allow the direct memory access (DMA) transfer to access secure memory in the input/output address (IO) range for the remote device in response to a determination that the remote device is authorized to access the input/output (I/O) address range.

6. The apparatus of claim 5, the hardware processor to:
retrieve an encryption key identifier (KEY_ID) for the trusted execution environment (TEE); and
assert the encryption key identifier (KEY_ID) in address bits of the direct memory access (DMA) transfer.

7. The apparatus of claim 1, the hardware processor to:
receive a request from the trusted execution environment (TEE) to terminate access by the remote device to the input/output (I/O) address range; and
set the pending bit to a second value which indicates that the remote device is not authorized to access the input/output (I/O) address range.

8. A method, comprising:
creating an input/output control data structure (IOCS) for a trusted execution environment (TEE);
allocating an input/output (I/O) address range comprising a host physical address (HPA) and a plurality of input/output (IO) pages to the input/output control structure;
creating an entry in the input/output control structure (IOCS) for a set of input/output (IO) pages and a device identifier for a remote device;
setting a pending bit to a first value which indicates that the remote device is authorized to access the input/output (I/O) address range; and
granting the remote device access to the set of input/output pages in the input/output control structure upon verification of an input/output (IO) address range for the remote device.

9. The method of claim 8, further comprising:
converting an input/output virtual address (IOVA) tot least one of a guest physical address (GPA) or a host physical address (HPA).

10. The method of claim 9, further comprising:
create a direct memory access (DMA) buffer in the set of input/output pages; and
program a direct memory access (DMA) circuitry with a source address and a destination address for a direct memory access (DMA) transfer between the device and the trusted execution environment (TEE).

11. The method of claim 10, further comprising:
receiving the direct memory access (DMA) transfer comprising encrypted data; and
decrypting the encrypted data.

12. The method of claim 11, further comprising:
allowing the direct memory access (DMA) transfer to access secure memory in the input/output address (IO) range for the remote device in response to a determination that the remote device is authorized to access the input/output (I/O) address range.

13. The method of claim 12, further comprising:
retrieving an encryption key identifier (KEY_ID) for the trusted execution environment (TEE); and
asserting the encryption key identifier (KEY_ID) in address bits of the direct memory access (DMA) transfer.

14. The method of claim 8, further comprising:
receiving a request from the trusted execution environment (TEE) to terminate access by the remote device to the input/output (I/O) address range; and
setting the pending bit to a second value which indicates that the remote device is not authorized to access the input/output (I/O) address range.

15. One or more non-transitory computer-readable storage media comprising instructions stored thereon that, in response to being executed, cause a computing device to:
create an input/output control data structure (IOCS) for a trusted execution environment (TEE);
allocate an input/output (I/O) address range comprising a host physical address (HPA) and a plurality of input/output (IO) pages to the input/output control structure;
create an entry in the input/output control structure (IOCS) for a set of input/output (IO) pages and a device identifier for a remote device;
set a pending bit to a first value which indicates that the remote device is authorized to access the input/output (I/O) address range; and
grant the remote device access to the set of input/output pages in the input/output control structure upon verification of an input/output (IO) address range for the remote device.

16. The one or more non-transitory computer-readable storage media of claim 15, further comprising instructions stored thereon that, in response to being executed, cause the computing device to:
convert an input/output virtual address (IOVA) tot least one of a guest physical address (GPA) or a host physical address (HPA).

17. The one or more non-transitory computer-readable storage media of claim 16, further comprising instructions stored thereon that, in response to being executed, cause the computing device to:
create a direct memory access (DMA) buffer in the set of input/output pages; and
program a direct memory access (DMA) circuitry with a source address and a destination address for a direct memory access (DMA) transfer between the device and the trusted execution environment (TEE).

18. The one or more non-transitory computer-readable storage media of claim 17, further comprising instructions stored thereon that, in response to being executed, cause the computing device to:
receive the direct memory access (DMA) transfer comprising encrypted data; and
decrypt the encrypted data.

19. The one or more non-transitory computer-readable storage media of claim 18, further comprising instructions stored thereon that, in response to being executed, cause the computing device to:
allow the direct memory access (DMA) transfer to access secure memory in the input/output address (IO) range for the remote device in response to a determination that the remote device is authorized to access the input/output (I/O) address range.

20. The one or more non-transitory computer-readable storage media of claim 19, further comprising instructions stored thereon that, in response to being executed, cause the computing device to:
retrieve an encryption key identifier (KEY_ID) for the trusted execution environment (TEE); and
assert the encryption key identifier (KEY_ID) in address bits of the direct memory access (DMA) transfer.

21. The one or more non-transitory computer-readable storage media of claim 15, further comprising instructions stored thereon that, in response to being executed, cause the computing device to:
receive a request from the trusted execution environment (TEE) to terminate access by the remote device to the input/output (I/O) address range; and
set the pending bit to a second value which indicates that the remote device is not authorized to access the input/output (I/O) address range.
